(19) United States
(12) Patent Application Publication
(10) Pub. No.: US 2016/0199260 A1
(43) Pub. Date: Jul. 14, 2016

(54) APPARATUS AND METHOD FOR CONTROLLED DOSAGE OF PILLS

(71) Applicant: SCANBIT A/S, Vodskov (DK)

(72) Inventor: Ole Christian Andersen, Sr., Vodskov (DK)

(21) Appl. No.: 15/023,420

(22) PCT Filed: Oct. 31, 2014
(86) PCT No.: PCT/DK2014/000051

§ 371 Date: Mar. 21, 2016

(30) Foreign Application Priority Data
Nov. 7, 2013 (DK) PA 2013 00632 7

(51) Int. Cl. A61J 7/00; B65B 57/06; B65B 1/32; B65B 1/04

(52) U.S. Cl. CPC A61J 7/0076; B65B 1/04; B65B 57/06; B65B 1/32; A61J 2205/10; A61J 2200/74; A61J 2200/30

(57) ABSTRACT

This invention is an apparatus that, connected to a computer program, controls the process of filling of pills in trays for medicine dispensers or pillboxes with multiple chambers. The apparatus is characterized by applying a control scanner and a precision weight for precise dispensing of the pills and by gate templates to guide the pills to selected chambers in the target pillboxes. Target chambers are automatically selected according to the pre-determined ingestion time. The pills will remain in the gate-template until the operator has conducted a visual inspection and/or performed a semi-automatic camera control to verify that the pills are properly distributed in the openings of the gate template. After the verification process, the pills are released into medication tray, by means of a mechanical device with double barrier plates, which are activated by a specialized release mechanism.

The present invention relates to dosing equipment, with a special dosing device for the controlled filling of pills in pill-trays with multiple cells destined for an automatic pill dispenser or pillboxes, which is used by patients in association with the ingestion of the daily-prescribed medicine. An increase in the number of citizens who are under medical treatment and development of new treatment options has resulted in a large increase in the number of patients who daily consume different types of medication several times a day. Those factors increase the risk of unintended incidents, in the form of medication errors, and may be harmful to the health of patients and society's economy. A part of unintended incidents, can be minimized by the use of automatic medicine dispensers or pillboxes, with an automatic reminder to patients which also releases the pills on the prescribed times of ingestion. One prerequisite for achieving the intended minimization of accidental incidents, which can obtained in relation to the use of automatic medicine dispensers, is that the filling process of the automatic medicine dispensers or pillboxes, are carried out correctly according to the patient's current prescription. This manual filling of the automatic dispenser and pillboxes, generally performed manually by the patients, in the health center or at a pharmacy. The filling process of pills in pill trays, places great demands on the medical staff, especially where pill-trays for dispenser or pillboxes, requires filling with different types of pills, to the releasing at different times of day. This invention comprises a dosage-dispensing device for pills that, designed to minimize the unintended medication errors, by ensuring correct dosage of the current prescribed medications in the pill trays, intended for subsequent use to patients automatic dispenser or pillboxes. This dosage-dispensing device, designed as an apparatus that implements the filling of pills in an unbroken chain of processes, with control of each process, from an empty pill tray inserted in the apparatus, to a finished dosed pill tray, that is ready delivery to the patient. The filling process, which is performed according to current and validated patient data, and delivered to the patient attached a patient ID label and medication information for attachment, ready to install in the patient's pill dispenser or pillboxes.

Current technical status: The known methods for filling of pills in pill trays used in pill dispenser and pillboxes generally performed manually by medical staff or by staff at a pharmacy. The manual filling of pills in pill-trays, implies a high risk of unintended incidents that can lead to a high rate of medication errors. A known alternative to manual filling of pills packaged on mechanical equipment, which packs the pills in plastic bags, or blister packs intended for the patient's daily ingestion of drugs. These installations have a size that makes them unsuitable for use as decentralized or mobile installations. Plastic packaged drugs packed in automated packing system can be difficult to handle and give no guarantee the timely ingestion. Other methods of dosage the dispensing of pills known as the patent US 2013/0056385, U.S. Pat. No. 6,779,663 B1, U.S. Pat. No. 0,057,231 2003 A1, that describes the system for filling of pills in trays or plastic bags, with only a single barrier plate to release of the pills. Patent EP00034320A, discloses an apparatus for dispensing pills, which comprises a gate template having opening in dispensing positions whereby the openings are in same positions as pockets for pills in a tray. The pockets are arranged in circular orientation and substantially equally spaced apart to thereby correspond with the orientation of said openings to hold the dispensed pills, which are to be dispensed for the patient. Patent US2010/0256808 A. U.S. Pat. No. 6,707,381 B1 discloses a system for automated dispensing, comprising an apparatus for dispensing pills in the tray to a dispensing unit, which trays are to be used by a patient. The system scans and reading the patient ID automatically and delivers the appropriate amount of the appropriate medication from the appropriate container system, is integrated with a computer program. U.S. Pat. No. 6,707,381 B1 which discloses a system for storage and dispensing of the units so as to align the units by means of a computer system that can be stored again in the same position. The present invention differs from the above-mentioned patents, in that it includes a system that uses exchangeable gate templates in variants, provided with openings according to the patient's current prescription. The openings in the gate-template is blocked by underlying dual interacting barrier plates, each of which has alternating openings and closed fields, which with one field displacement is blocks the openings in all positions in the gate template. The pills are weighed on a precision scales and be distributed to the openings in the gate template where the pills are prevented from falling into the pill tray of the two interacting barrier plates. The two interacting barrier plates can assume three positions, in the non-actuated position blocks the two barrier plates on all positions of dosing, which allows the operator to check for the manual distribution of the pills in gate template is correct, according to the doctor's prescribed times. Checks on the correct distribution of pills openings in the gate template, performed as visual inspection supplemented by camera control.

Checks on the correct distribution of pills openings in the gate template, performed as visual inspection supplemented by camera control. The underlying interacting double barrier plates, which prevent the pills from falling into pill-tray, may assume three positions, by activated with a special trigger mechanism. The special trigger mechanism can bring the underlying interacting double barrier plates into the open positions, using a two-stage activation of the special trigger mechanism. In the first step of activation of the release mechanism, both barrier plates is brought into its second position, wherein the one barrier plate, are displaced an open barrier plate position forwards, compared to the other barrier plate, so that the openings of the two barrier plates are above one another, thus allowing passage of the pills, distributed to the openings of the gate-template in every other dosing position.

In the second step of the activation of the release mechanism, both barrier plates is brought to its third position where the openings in the barrier plates is still above one another, but overall shifted one dosing position forwards, which allows the passage of the remaining pills, that are distributed to the gate template on the remaining dosing positions. With this structure with two interacting barrier plates, which is adapted to toggle between 3-position, by a two steps actuating, it is possible to use the pill trays where the cells are located quite close to each other, only separated by a thin partition wall.

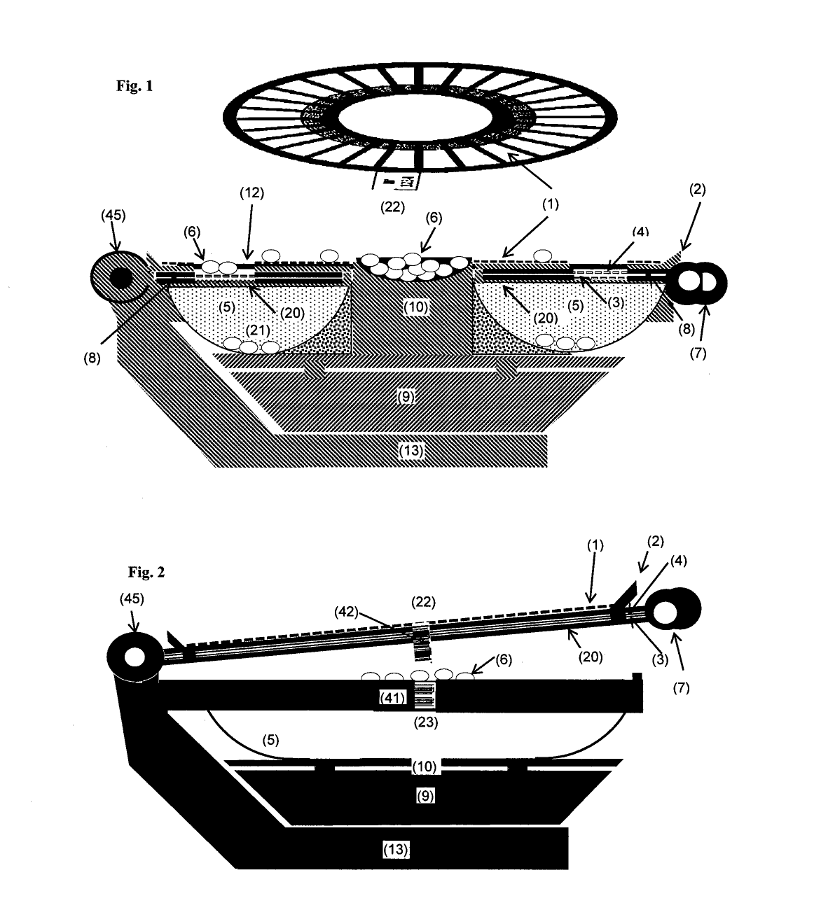

FIG. 1

(1) Gate-template

(2) Upper plate

(3) Upper barrier plate

(4) Lower barrier plate

(5) Pills tray

(6) Pills

(7) Mechanism for release

(8) Guide pins

(9) Precision scale

(10) Scale pan

(12) Openings in the gate template

(13) Console

(20) Abutment plate

(21) Pills in pill tray

(22) Control flip

(45) Overall dosing unit

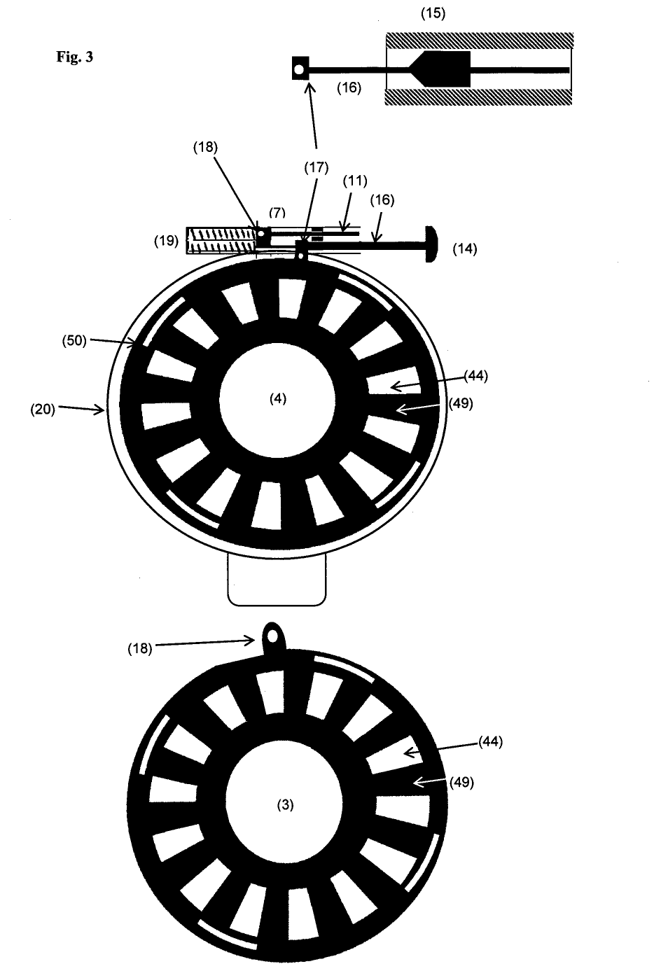

FIG. 2

(1) Gate-template

(2) Upper plate

(3) Lower barrier plate

(4) Upper barrier plate

(5) Pills-tray

(6) Pills

(7) Mechanism for release

(9) Precision scale

(10) Scale pan

(13) Console

(20) Abutment plate

(22) Control flip

(23) Barcode at the pill tray

(41) Opening for scanning in console

(42) Barcode at the control flip

(45) Overall dosing unit

FIG. 3

(7) Overall mechanism for release

(11) Additional shaft

(14) Handle

(15) Electrical actuator

(16) Operating shaft

(17) Coupling on the lower barrier plate

(18) Coupling on the upper barrier plate

(19) Springs

(20) Abutment plate

(44) Open fields of the barrier plate

(49) Closed fields of the barrier plate

(50) Circular guide grooves

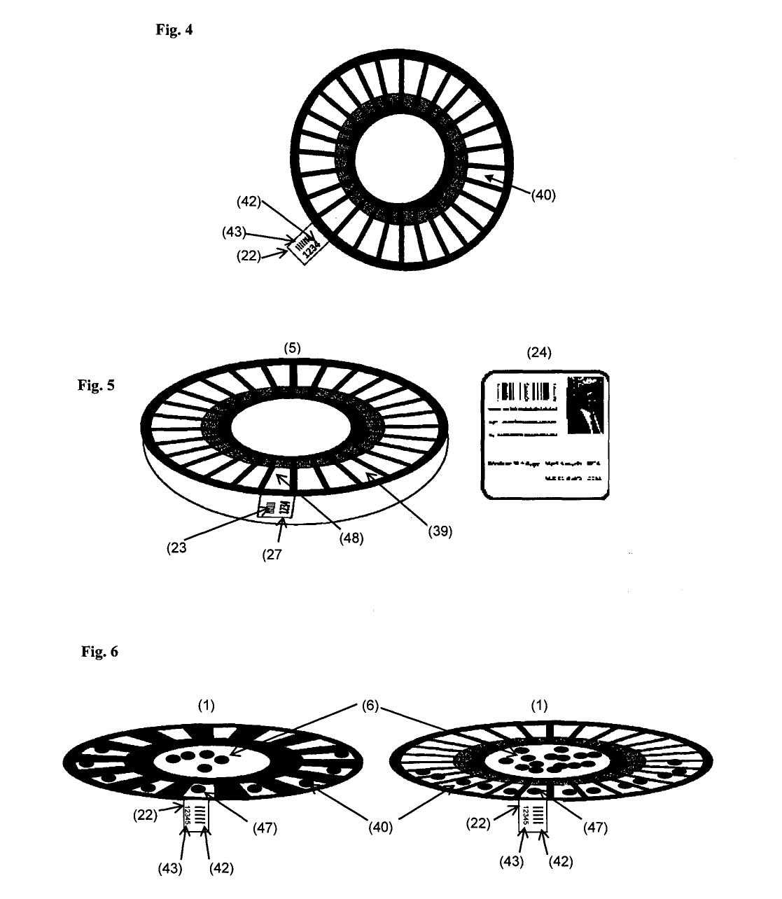

FIG. 4

(1) Gate-template

(22) Control flip on the gate-template

(40) Dosing-positions

(42) Barcode number on the control flip of gate-template

(43) Barcode on the control flip of gate-template

FIG. 5

(5) Pill tray

(23) Barcoded by pill tray starts-chambers

(24) Patient's ID label

(27) Serial number of the pill tray

(39) Cells of the pill tray

(48) Starting cell of the pills tray

FIG. 6

(1) Gates-template

(6) Pills

(22) Control flip of the gate template

(40) Dosing-positions

(42) Barcode on control flip of the gate template

(43) Barcode number on control flip of gate template

(47) Starting field of gate template

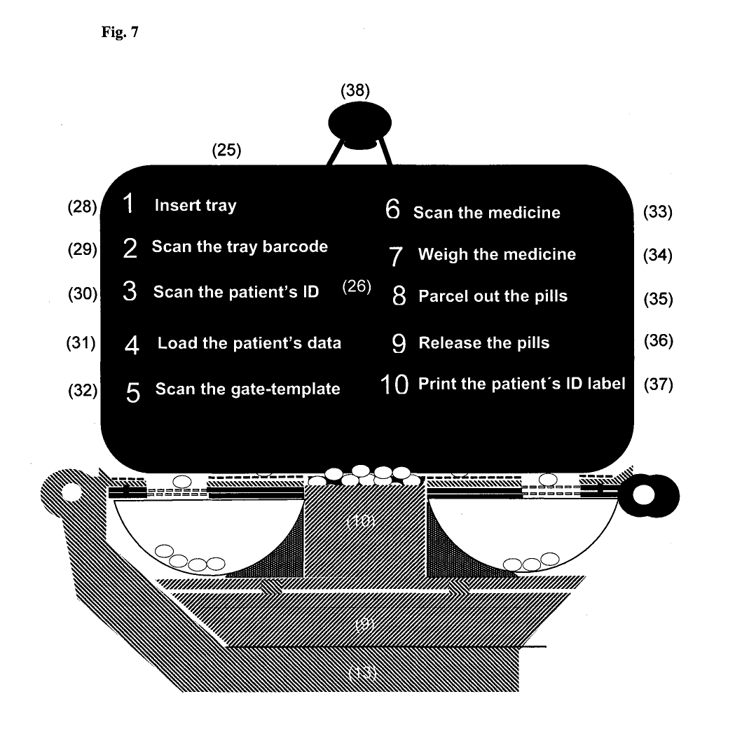

FIG. 7

(9) Precision scale

(10) Scale pan

(13) Console

(25) Process Computer

(26) Process computers touch screen

(28) Process step 1: Insert pill tray

(29) Process step 2: Scanning pill tray serial number

(30) Process step 3: Scanning the patient ID

(31) Process step 4: Import the current prescribing data

(32) Process step 5: Scanning gate template

(33) Process step 6: Scanning pill container

(34) Process step 7: Weigh the medicine

(35) Process step 8: Distribution of pills

(36) Process step 9: Unlocking the pills

(37) Process step 10: Printing patient's ID label

(38) Camera

An exemplary embodiment of a dosage-dispensing device according to claims 1-5, which is constructed as an apparatus for filling the pills (6), in a pill trays (5), with a multiple cells, which is intended for patients' pill dispenser or pill boxes. Dosage-dispensing device is constructed with a console (13), having the function as the chassis in the dosage-dispensing device. The console (13) has an overall dosing unit (45), pivotally mounted with a hinge joint, which makes it possible to tilt the dosing unit (45), up and provide space for the insertion of the pill trays (5). Dosing unit (45), which are designed to guide the operator to perform the distribution and filling of the pills (6), to the cells in the underlying pill-tray (5). The dosing unit (45) as is a assembled unit comprising an upper plate (2), intended for the location of the replaceable gate templates (1), in the middle, immediately below the upper plate (2), has the dosing unit (45) two interacting barrier plates (3,4), and in the bottom of the dosing unit (45) an abutment plate (20) which supports the two interacting barrier plates (3.4). The two interacting barrier plates (3, 4), will prevent the pills (6) falling down into the pill tray (5) before a verification of the correct distribution is performed. To activate the two interacting barrier plates (3, 4), is there on the abutment plate (20) mounted a two-stage mechanism for release (7). The overall dosing device (45) is attached with a hinge joint to the console (13) such that the total dosing unit (45) can be turned up and provide a space for the insertion of the pill-tray (5). The two interacting barrier plates (3, 4) located below the upper plate (2), each has alternating openings (44) and closed (49) fields. The two interacting barrier plates (3, 4), which in the rest position is offset a field relative to each other, so that the closed fields (49) on the one barrier-plate, blocks the open fields (44) on the other barrier-plate and thereby gives closed fields at all dosing positions (40). In order that the two barrier plates (3, 4) can be circularly shifted, there is four circular guide grooves (50), in each of the two barrier plates (3,4), intended for the guide pins (8) which is mounted on an underlying abutment plate (20), so that the guide pins (8) passes through the guide grooves (50) and enables for the barrier plates (3,4), to displace the position in the circular direction. The circular change of the position of the barrier plates (3.4), allows the barrier plates (3.4) to assume three positions. The first position is non-activated rest position with closed barrier plate fields (44) at all dosing-positions (40). The second position, wherein one barrier plate is shifted one barrier plate field relative to the other barrier plate, thus that the open barrier plate fields (44) are on same position. The third position where the openings (44) of the two barrier plates (3.4) still is on the same position, but overall is moved one field forward. To activate the two barrier plates (3,4) in the three positions, is there on the abutment plate (20) a fixedly mounted an overall mechanism for release (7), which with a two-step actuation, brings the barrier plates (3,4) in the three positions. The overall mechanism for release (7) comprises an operation shaft (16), with a fixed coupling (17), which is coupled to the lower barrier plate (4), and an additional shaft (11), with a fixed coupling (18), which is coupled to the upper barrier plate (3). The couplings (17, 18) which are pivotally coupled to the barrier plates (3, 4), such that the circular activation of the barrier plates (3, 4), can be performed. The overall two stage mechanism for release (7) of the barrier plates (3,4), can using a two-stage axial actuation, of an operation shaft (16), bring the two barrier plates (3.4), in changing open positions, at all dosing-positions (40). In order to bring barrier plates (3,4), back into closed position, are the operation shaft (16) and additional shaft (11) spring-loaded by springs (19). In the first step of the two-step activation, of the overall two stage mechanism for release (7), affected of operation shaft (16) together with the fixedly mounted coupling (17), which is coupled to the lower barrier plate (4), which is hereby brings the lower barrier plate (4) one field forward, relative to the upper barrier plate (3), such that openings (44) of both barrier plates (3,4) are on the same position, and will open to the pills (6), which are laid in the openings (12) in gate template (1), in every second dosing-positions (40. In the second stage of actuation of the overall two-stage mechanism for release (7), will the further actuation of operation shaft (16) with attached coupling (17), affect coupling (18) which is coupled to the upper barrier plate (3), this will move the open fields (44), of the two interacting barrier plates (3, 4), a field forward relative to the dosing-positions (40). The activation of the two interacting barrier plates (3, 4) together, with open fields (44), one dosing position (40 forward, will release the pills (6), which is loaded in the remaining openings (12), into gate template (1). After activation will the barrier plates (3,4), be pushed back to a position with alternating closed fields (49), by return springs (19), Operating shaft (16) of the overall two stage mechanism for release (7), activated manually with the handle (14), or with electric actuator (15). In order for pills (6), not to rub against the edges by the openings (44) on the upper barrier plate (3), is activated the lower barrier plate (4) first, so that there is only a smooth surface that move under the pills (6). By the use this construction with barrier plates (3,4), which is interacting and can assume three positions, it is possible to use pill-trays (5), where the cells (39) in the pill tray (5), is located quite close to each other, only separated by a thin partition wall. The console (13) where the upper part encloses the pill tray (5), has a built-in precision scale (9) with the scale pan (10), which acts as the placement facility for pill tray (5), used for weighing up the pill-trays (5) and the pills (6) to be dosed in the pill tray (5). The scale pan (10) placed in the same level, as the upper plate (2) with gate template (1), which has the effect, that the weighed pills (6), can directly distributed manually into the openings (12) in gate template (1). The console (13) has an opening (41) in the upper part of the circular part which surrounds the pill tray (5), which is intended for scanning and positioning of the barcodes (23,42) on the pill tray (5) and the gate template (1). A correct scanning of barcodes and the positioning of the units is obtained when the pill tray (5), is placed on the scale pan (10), or when the gate-template (1) placed on the upper plate (2) of the dosing unit (45), with the bar codes (23,42), shown in the opening (41). Thereby ensuring the correct positioning of the start cell (48) on the pill tray (5), and a correctly positioned start field (47), on the gate template (1). The gate template (1), which designed to guide the operator, in distribution of the pills to the openings (12) in the gate template (1), which placed over those cells in the pill-tray (5), which is destined to receive pills (21). The gate template (1), intended for placed on the upper plate (2) of the dosing unit (45) and used in variations with openings (12), in different dosing positions (40) which is in accordance with the prescribed times for ingestion, for each type of pills (6). The gate template is changed for each type of pills, unless it is the same times that are prescribed. In order to apply the correct gate-template (1), and the correct positioning on the upper plate (2) at the dosing unit (45), the gate-template (1) has a control flip (22) with barcode (42), and a barcode number (43) intended for positioning and scanning of the gate-template (1). The correct positioning of the gate-template (1), ensured by placing the control flip (22) with barcode (42) in the opening (41) on the console (13). Use of the correct gate template (1), ensured by scan of the barcode number (43) and compare the number with the barcode number, generated by the process computer (25) and displays on the touch screen (26). The dosage-dispensing device comprises, in addition to overall dosing unit (45) which pivotally mounted on the bracket (13), also of a process computer (25) with a touch screen (26), and a process application installed on the process computer (25) with a data connection to a central patient server. The dosage-dispensing device comprises further and a printer for printing of patient-ID and medication information. As control devices connected to the process computer (25) comprises the dosage-dispensing device a precision scale (9) a barcode scanner and a camera (38). Method of using dosage-dispensing device according to claims 1-4, designed to refill pills (6) in pill-trays (5), in accordance with the patient's current ordination. The pill trays (5) intended for subsequent use in the patients' automatic dispensing equipment, which is adapted to the releasing of the pills, at the times prescribed by the physician. The dosage-dispensing device is characterized by to implement the complete dosing process in a number of process steps, where each process step must meet at least one absolute control condition, to continue of the filling process. The result is that the dosing process is prevented from being completed, if an error occurs in the filling process. The filling process of pills (6), in pill trays (5), starts with an empty pill tray (5), which inserted into the dosing dispensing device, to a finished filled pill tray (5), with attached medication information and patient's ID label (24).

In the first process step (28), an empty pill tray (5) will be placed in the balance (10), with the bar code (23) on the pill tray (5), shown in the opening (41) for scanning the bar code (23). This will ensure proper positioning of the pill tray (5) with start cell (48) on pill tray (5) in the opening (41). The process computer (25) will at the same time control that the weight of pill tray used (5) is equal to the known weight of an empty pill tray (5) (This data as is known by the process computer (25)). The process computer (25) performs a control on the weight of the used pill-tray (5) is equal to the weight of an empty pill tray (5); the proper weight of the applied pill tray (5) is a condition for the process to continue.

In the second step in the process (29), the serial number (27), is scanned on the pill tray (5), shown in the opening (41) in the console (13). The scanned serial number (23) is stored in memory in the process computer (25), for subsequent linkage to the current patient ID (24), this will prevent pill tray (5) in becoming be exchanged for another pill-tray (5). When the serial number (27) in the pill tray (5) is scanned, the scan will be conditional on the process computer (25) also detects the weight of an empty pill tray (5) placed on the balance pan (10). This verifies that it is an empty pill tray (5) that has been placed on the scale pan (10) and that the pill-tray (5) has been positioned correctly with the starting cell (48) in the opening (41), which is a precondition for the process to be continued.

In the third process step (30) a scan of the patient ID (24) label is performed, which is characterized by the process computer (25), by scanning connects serial number (27) of the empty pill tray (5), together with the patient ID (24), which must provide guarantee that it is the right pill tray (5), which is used for the current patient. The process computer (25) checks the pill tray (5) remain on precision weight (9), and continues this control the rest of the dosing process, the removal of the pill tray (5), from the balance pan (10) will interrupt the dosing process and will require a new registration of a pill-tray (5). The correct weight of the empty pill tray (5), detected on the scale pan (10) is a precondition for continuation of the dosing process.

In the fourth process step (31), whose purpose it is to start the transfer of the patient's current prescription data from a central patient server, the transfer is started by scanning the patient ID (24) label and is characterized by the patient's current prescription data, is the data basis for generating the process data. At the same time, as the patient's data is transferred, a check is performed on the pill tray weight effect, is the same as the weight of an empty pill tray (5), which is a condition for a continuation of the process.

In the fifth process step (32), a gate template is selected (1) following the barcode number (43), which is shown on the touch screen (26), barcode number (43) on the gate template (1) is calculated from the physician's prescription time schedule and the number of days pill tray (5) intended to. The number of days pill tray (5) intended to be used will by default be the maximum of days that have cells in pill tray (5), in relation to the number of daily ingestions indicated in the current prescribing. If a smaller number of days is required, it is possible to enter a smaller number of days; it will change and display a new barcode number (43) on the touch screen (26). The selected gate template (1) is correctly placed on the upper plate (2) when the control flip (22) with the barcode (42) is in the opening (41), intended for scanning of barcodes, the barcode number (43), is scanned and controlled by the process computer (25), a correct scanned barcode number (43), is a condition for a continuation of the process.

In the sixth process step (33), the operator selects the pills, which will be filled into the pill tray (5). The choice of the patient's current prescribed medications is done according to the name and barcode number on the medication that appears on the touch screen (26). Barcode number on the drug container is scanned and controlled by the process computer (25) which control the barcode number is the same as it that is prescribed according to the patient's current patient data; a correct scanned barcode number on medicine, is a condition of the process can be continued.

In the seventh process step (34), a weighing of the pills performed. The operator weighs the first 1 pc. pill from the selected drug container, the weight of 1 pc. pill is stored in the process computer (25) and subsequently used for calculating, of the total weight and the number of pills (6) to be filled into pill-tray (5) in this current filling. The number of pills (6) and the total weight of the pills (6) calculated using the weight of the first 1 pc. pill weighed, and the number of pills (6) to dosed according to patient's current patient data. The process computer (25) display the total weight and the total number of pills (6) on the touch screen (26). The operator adds scale pan (10) the number of pills, after which the process computer (25) signals, when the weight of the pills (6) is correct, the correct weight of the pills (6) into the scale pan (10), is a condition of the dosing process can continue. In the eighth process step (35), the operator performs the distribution of the pills (6) into the openings (12), on the gate template (1). The distribution of the pills are done manually according to instructions on the touch screen (26), the operator performs a visual check of the distribution and then confirms correct distribution on the touch screen. (26) A control of the correct distribution of the pills (6) the openings (12) on the gate template (1), can be verified with the camera (38), with the camera (38) verification, will the correct distribution of the pills (6) in the openings (12), be a condition for the process to continue. If there is access to the pills picture ID of the pills (6), the process computer (25) can check whether the pills shape, color and size are similar to the pills picture ID, and thus perform a check, whether it is they correct pills that are delivered.

In the ninth process step (36) performed an actuation of the two interacting barrier plates (3, 4), which is hereby releases the pills (6) loaded in the openings (12), on the gate-template (1). The release of the pills (6), characterized by being carried out, using a two-step activation of the mechanism for release (7). The first step is released the pills (6) loaded in every other dosing positions (40). In the second step, the pills (6), will be released on the remaining positions of dosing (40), the activation can be effected by manual actuation of the operating handle (14), or by electrical actuation of the actuator (15). Following the release of the pills (6) to the cells in pill tray (5), the process computer (25) will calculate the sum of the weight of the added pills (21) and check whether the weight increase is correct, for every filling with pills (6) to the pill tray (5). A correct weight increase is a condition for continuation of the process.

In the tenth process step (37) whose purpose is to complete or continue a further filling of the current pill tray (5), characterized by further filling repeated from the fifth process step (32), until there are no more prescribed pills (6) to be filled according to the patient's total prescribing, contained in the current patient data. After completion of the filling process, the process computer (25) performs a control on the weight increase in pill tray (5), the weight increase must be equal to the sum of the weight of the total number of pills (6), calculated according to the patient's total current patent data. A correct weight increase is a precondition to filling process can be completed and that can be printed label with the current patient ID (24), with associated medication information, and barcodes to control scanning on delivery and setting data for subsequent use for setting the patient's automatic pill dispensers.

1. A dosage-dispensing device for pills (6) comprising the gate-templates (1), an upper plate (2), and two interacting barrier plates (3,4), an underlying abutment plate (20) with guide pins (8), a dual stage release mechanism (7). These devices characterized as an overall dosage unit (45) which used to distribute the pills (6) into selected cells of the pill boxes (5). Dosage-dispensing device further comprises a console (13), a process program, a process computer (25) with touch screen (26), a printer, a data connection to the patient server, a precision scales (9) with scale pan (10), a barcode scanner, and a camera (38).

2. A dosage-dispensing device for the pills (6) according to claim 1, characterized by a special overall dosing unit (45), which uses exchangeable gate templates (1) in different variations, which are intended for location on the upper plate (2). The upper plate (2) has two underlying interacting barrier plates (3, 4) with circular guide grooves (50), intended for the guide pins (8) which is mounted on the underlying abutment plate (20) so that the guide pins (8) passing through the circular guide grooves (50) of the two interacting barrier plates (3, 4), which will allowing the barrier plates to switch circular position. The two interacting barrier plates (3,4) having alternately of closed (49) and open fields (44), there in rest position is offset one barrier plate field, relative to each other, so that the closed areas (49) of the one barrier plate, blocking the opened fields (44) of another barrier plate, thereby are there closed barrier fields (49), on all dosing-positions (40). Barrier plates (3.4) can assume three positions, the first is a rest position with closed fields on all dosing-positions (40), the second position, where the barrier plates (3,4) are shifted one field in the relation to each other, and the third position, where the openings (44) of the two barrier plates (3.4), still are on the same position, but together is moved a field forward. To activate the barrier plates (3,4) in the three positions, is there on the abutment plate (20) fixedly mounted a dual stage release mechanism (7), which with an operation shaft (16) and an additional shaft (11), is connected to the two barrier plates (3.4), so that in a two-stage activation can switch between the three positions.

3. A dosage-dispensing device for the pills (6) according to claims 1 and 2, characterized by a dual stage release mechanism (7), mounted on the abutment plate (20). The dual stage release mechanism (7), comprising an operating shaft (16) with the coupling (17) which is coupled to the lower barrier plates (4), dual stage release mechanism (7) has further additional shaft (11) with coupling (18) which is coupled to the upper barrier plate (3). The dual stage release mechanism (7), can with a two-step axial activation of the operating shaft (16), bring the double barrier plates (3, 4) in an alternating open position, at all dosing positions (40). In the first step of axial actuation of the operating shaft (16), will the operating shaft (16) with a permanently affixed coupling (17) which is movably coupled to the lower barrier plate (4), by actuation bringing the lower barrier plate (4), moving one field forward, which brings both barrier plates alternating openings (44) at the same position. This position at barrier plates (3.4) will provide openings for the pills (6), which is loaded in the openings (12) in gate template (1) on each other dosing-position (40). In the second step of further activation of the operating shaft (16), push the coupling (17) on the coupling (18), which is coupled to the upper barrier plate (3), which is hereby will move the open barrier fields (44), of the both barrier plates (3,4), overall a field forward relative to dosing-positions (40). This activation will give open barrier fields (44), for the pills (6) there loaded in the remaining openings (12), in the gate-template (1). After the end of activation, will both barrier plates (3.4) be pushed back, to a position with alternating closed fields (49), of the springs (19). Operating shaft (16) of the dual stage release mechanism (7), activated manually with the handle (14) or with an electrical actuator (15). For the pills (6) should not be damaged by the edges of the open barrier fields (44), is activated the lower barrier plate (4) first, so that only are smooth surfaces which move under the pills (6).

4. A dosage-dispensing device for pills (6) according to claim 1, characterized by having a console (13) there have function as the chassis of the dosage-dispensing device, with built-in precision scale (9) with scale pan (10) which is the abutment for the pill-trays (5). The console (13) has further the overall dosing unit (45) pivotally mounted, which makes it possible to tilt overall dosing unit (45) up, and give space for the inserting of the pill-tray (5). In the upper part of the console (13), that encloses the pill-tray (5), is an opening (41) intended for the scanning and positioning of the barcodes (23,42) on the pill-tray (5) and the gate-template (1), when the pill-tray (5) is inserted on the scale pan (10), or when the gate-template (1) is placed on upper plate (2). The barcodes (23, 42) are respectively located at start cell (48) on the pill-tray (5) and on the control flip (22) at start field (47) on the gate-template (1), which ensures correct positioning by scan of the devices.

5. A method for the controlled dosing of pills (6) according to claims 1-4, characterized by the use of a dosage-dispensing device, with associated the overall dosing unit (45) for filling the pills (6) in pill-trays (5). The process for filling the pills (6) into pill-trays (5) is divided into an unbroken chain of controlling process steps, performed on the basis, of the patient's current prescription data, transferred from a central database server. The process for filling starts with, an empty pill-tray (5) is inserted into the dosage-dispensing device, and continues in ten-process step, until a finished filled pills-tray (5), there is ready for delivery to the patient, with attached patient ID label (24) and information about the medicine. In the first process step (28) by the use of the dosage-dispensing device, starts with to place an empty pill-tray (5) on the scale pan (10). The location of the pill-tray (5), characterized by that the barcode (23), only is visible, when the pill-tray (5) is correctly positioned, with the start cell (48), positioned at the opening (41) in console (13). After placement the pill-tray (5) on the scale pan (10), will the process computer (25) detects, whether the weight of pill-tray (5) is equal to the weight of an empty pill-tray (5), which is a condition for the process, can continue to the next process step.
In the second process step (29) by the use of the dosage-dispensing device, is performed a scan with barcode scanner, of the barcode (23) on the pill-tray (5). The scan characterized by the scanning of the barcode (23) with the serial number (27), in the opening (41), only can be performed if process computer (25), at the same time detects the weight of an empty pill-tray (5) which is located on the scale pan (10). This will ensure that it is an empty pill-tray (5), which placed on the scale pan (10). The serial number of the pill-tray (5) will be stored in memory of the process computer (25), for subsequent connection to the patient ID (24). The scan of the barcode (23) in the opening (41), ensures a correct positioning of the start cell (48) of the pill-tray (5). Process computer (25) detects that the pill-tray (5) is located on the precision scale (9), which is a condition for the process can continue to the next process step.
In the third process step (30) by the use of the dosage-dispensing device, performed a scan with barcode scanner of the ID (24) of the current patient, which is characterized by, the process computer (25) here after connects the serial number (27) on the empty pill-tray (5) which In the 2. process step (29) is stored in memory, with ID (24) of the current patient. At the same time as the scan of the patient's ID (24), performed a control of the correct weight of the empty pill-tray (5), the correct weight of the empty pill-tray (5) is a condition for the process be continued to the next process step.
In the fourth process step (31) by the use of the dosage-dispensing device, will the prescription data, which is prescribed for the current patient, will be transferred from the central data server. The transfer characterized by to start, by scanning of the current patient's ID label (24). Process computer (25) transfers the prescription data for the application, and there be initiated a persistent control on, about the pill-tray (5) remains on precision scale (9) during the subsequent filling process, which is a condition for the process not interrupted.
In the fifth process step (32), by the use of the dosage-dispensing device, characterized by the operator selects gate-template (1), whose purpose is to guide the operator in the distribution of the pills (6), to the openings (12) in the gate-template (1), there is placed above the cells (39) of the pill-tray (5), and are predetermined to receive the pills (6). The gate-template (1) there are available in different variants, with openings on different dosing-positions (40), calculated in accordance to times, for intake of prescribed medications, and displayed as bar code number on the touch screen (26). The operator selects gate-template (1) after the displayed barcode number (43), which then places the gate-template (1) on the upper plate (2), with the control flip (22), in the opening (41), intended for scanning and positioning. The operator scans the barcode (42) with barcode scanner, there subsequently controlled of the process computer (25) for a correct scanned barcode number (43). A correct scanned barcode number (43) is a condition for the process to continue.
In the sixth process step (33) by the use of the dosage-dispensing device, characterized by that the operator selects medicine container with the pills (6), which according to the patient's current prescribed medication data, must be bottled pill-tray (1). Medicine container selected by name and associated barcode number, shown on the touch screen (26). The operator scanner the bar code on the selected medicine container, which subsequently be verified of the process computer (25), a correct scanned barcode number, is a condition of the dosing process, can continue to the next process step.
In the seventh process step (34) by the use of the dosage-dispensing device, performing a weighing of the pills (6), to the current filling, the weighing characterized by, first weighs the operator 1 pc. pill at the scale pan (10), if result saved of process computer (25), which is subsequently uses the result for that calculate the number of pills (6), which intended to be filled in the pill-tray (5), according to the patient's current prescription data. The calculated number of pills (6) and the total weight of the pills (6), will displayed on the touch screen (26). The operator adds the scale pan (10) showed number of pills (6) which verified by process computer (25), which sends a signal when the weight is correct. A correct weight of the pills (6) at the scale pan (10), is a condition of the dosing process can continue.
In the eighth process step (35) by the use of the dosage-dispensing device, is performed a distribution the pills (6) from scale pan (10) to the openings (12) in the gate-template (1). The distribution of the weighed pills (6), characterized by that the distribution performed manually, with visual inspection by the operator, who confirm correct distribution with acceptance on the touch screen (26). The verification of correct distribution of the pills (6) in the gate-template (1) verified with the camera (38). A correct result of camera verification, of the distribution of the pills (6), into the openings (12) in the gate-template (1), will be a condition of the dosing process; can continue to the next process step.
In the ninth process stage (36) by the use of the dosage-dispensing device, is performed the opening of the double barrier plates (3.4), characterized by the opening of the barrier plates (3.4) will release the pills (6) down into the pill-tray (5). Barrier plates (3, 4) opens by activation of a dual stage release mechanism (7) which performed by actuation of the handle (14) or with electrical actuator (15). After release of the pills (6) down into the pill-tray (5), will the weight increase of the pill-tray (5) with the additional pills (21), being verified by the process computer (25). A correct weight increase, registered by the process computer (25), is a condition of the dosing process can continue to the next process step.
In the tenth process step (37) by the use of the dosage-dispensing device, characterized by the continuation of the filling of same pill-tray (5), the filling repeated from the 5th process step, until there are no more pills (6) for dosing in the pill-tray (5), according to current prescription. After the completion of the filling of pills (6), process computer (25) performs a check, on whether the total weight increase, of pill-tray (5), is equal to the sum of the weight, of the total number of pills (21) which filled in the pill-tray (5). The weight of the total number of pills (21), which are filled in the pill-tray (5), checked to be consistent with the weight of the pills (6) that is prescribed in the patient's current prescription data. A correct weight increase, is a condition for completion of the dosing process, with subsequent printing of patient ID (24) label, with the current prescribing information and barcodes, which affixed on the pill-tray (5), there after sealing is ready for delivery to the current patient.
